(19) United States
(12) Patent Application Publication
(10) Pub. No.: US 2003/0164159 A1
(43) Pub. Date: Sep. 4, 2003

(54) Constrained layer damping system

(76) Inventors: Jeff J. Klas, Brighton, MI (US); Mark K. Rhodes, Ferndale, MI (US); Michael D. Bennett, Westland, MI (US); Dan Guglielmo, Plymouth, MI (US)

Correspondence Address: BRINKS HOFER GILSON & LIONE, P.O. BOX 10395, CHICAGO, IL, 60611, US

(21) Appl. No.: 10/090,923

(22) Filed: Mar. 4, 2002

(51) Int. Cl. F02M 35/10

(52) U.S. Cl. 123/472; 123/184.24; 123/143 C

(57) ABSTRACT

A constrained layer damping system for use in an integrated air fuel module having a control module mounted thereon is provided. A control module and a wiring harness extending from the control module are coated with an encapsulant. A first layer of formed material is placed on a first side of the wiring harness and a first side of the control module, and a second layer of formed material is placed on a second side of both the wiring harness and the control module.

### CROSS REFERENCE TO CO-PENDING APPLICATIONS

This application is related to co-pending application entitled “Integrated Fuel Delivery and Electronic Powertrain Control Module and Method of Manufacture,” U.S. Patent Application No. ______, assigned to the same assignee as the present invention and filed Jan. 31, 2002. The entire contents of the co-pending application are hereby incorporated by reference.

### FIELD OF THE INVENTION

The invention relates generally to the field of noise reduction and electromagnetic shielding in engines. In particular, this invention relates to a constrained layer damping system that reduces noise and electro-magnetic interference emitted from an engine by using embedded wiring with or without a power control module to form a constrained layer damping treatment. The present invention could allow a powertrain control module to be mounted directly on an engine without being negatively affected by noise, vibration, or electromagnetic interference from the engine.

### DESCRIPTION OF THE RELATED ART

In internal combustion engines, noise emitted from air induction systems is a concern to the operator of the equipment. In the past, various methods of absorption and reflection have been used to control the emitted noise. Such methods include applying a layer of viscoelastic polymer to a substrate in order to dampen the vibration.

The powertrain control module (PCM) is a unit separate from the air intake manifold in conventional engines. Normally, the PCM is mounted in the passenger compartment of the vehicle, on the vehicle firewall, or on the engine itself, away from the high-temperature components of the engine. Traditionally, noise vibration harshness (NVH) shields are employed to reduce noise emitted by the powertrain to reduce their effect on the operator. Electro-magnetic interference (EMI) shielding is used to shield sensitive components of the PCM from electromagnetic noise that would otherwise interfere with the PCM's operation.

Wiring harness are used to connect the PCM to various sensors and actuators under the hood, and may be constructed of round wire, silicone over-molded harness, or flat wire. It would be beneficial to increase the NVH and EMI shielding characteristics of this system while also reducing package size and system complexity. By mounting the PCM in an “on-engine” location, wiring harness cost and complexity could also be reduced. The constrained layer treatments of the prior art do not provide such a mounting configuration.

### BRIEF SUMMARY OF THE INVENTION

In a first embodiment of the present invention, a constrained layer damping system for use in an integrated air fuel module having a control module mounted thereon is provided. A control module and a wiring harness extending from the control module are coated with an encapsulant. A first layer of formed material is placed on a first side of the wiring harness and a first side of the control module, and a second layer of formed material is placed on a second side of both the wiring harness and the control module.

In a second embodiment of the present invention, a constrained layer damping system is provided. A wiring harness is coated with an encapsulant and a first layer of formed material is placed on a first side of the wiring harness. A second layer of formed material is placed on a second side of the wiring harness.

In a third embodiment of the present invention, a method for reducing the effects of noise emitted from a powertrain and electromagnetic interference on a control module is provided. The method includes the steps of providing a control module and a wiring harness and encapsulating both the control module and the wiring harness with a damping material. The control module is mounted on an air intake manifold plenum cover and a constraining layer of formed material is mounted on the side of the control module and the wiring harness opposite the air intake manifold plenum cover.

### BRIEF DESCRIPTION OF SEVERAL VIEWS OF THE DRAWINGS

FIG. 1 is a schematic cross-sectional view of an embodiment of an integrated air fuel module and control module utilizing the constrained layer damping system of the present invention;

FIG. 2 is a cross-sectional view along line 2-2 in FIG. 1; and

FIG. 3 is a perspective view of an embodiment of an integrated air fuel module and control module utilizing the constrained layer damping system of the present invention.

### DETAILED DESCRIPTION OF THE PREFERRED EMBODIMENTS OF THE INVENTION

The present invention allows for the integration of a powertrain control module (PCM), the engine wire harness, noise vibration harshness (NVH) shielding, electromagnetic interference (EMI) shielding, and an electronics cooling mechanism with the intake manifold of an integrated air fuel module (IAFM) or other vehicular system. The integration of these components allows for reduced package size and reduced cost of manufacture. The weight of the system is also reduced, and the NVH characteristics are improved. The NVH and EMI shielding of the present invention allows for the PCM to be mounted directly on the air intake manifold or any other vehicular system that emits vibration and/or EMI.

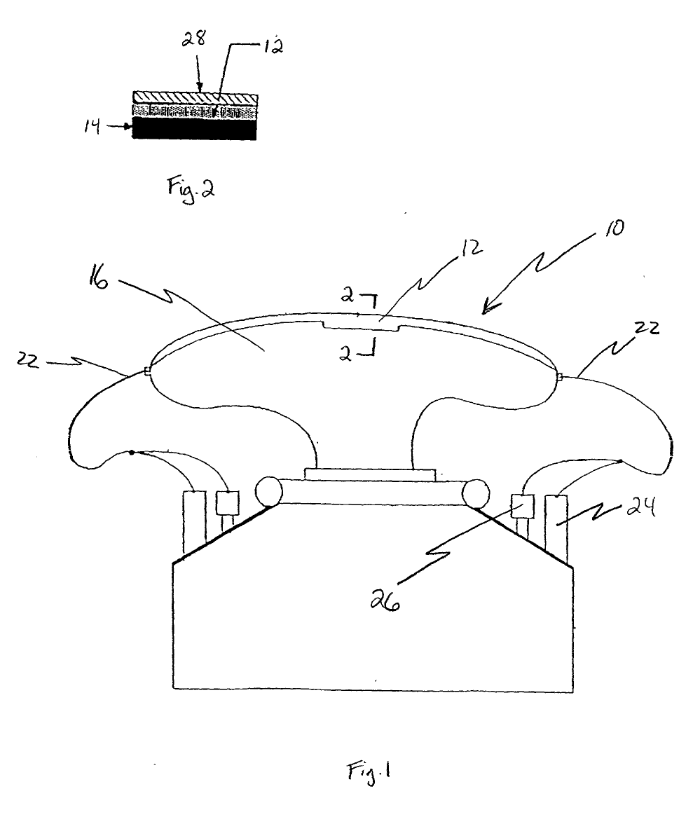

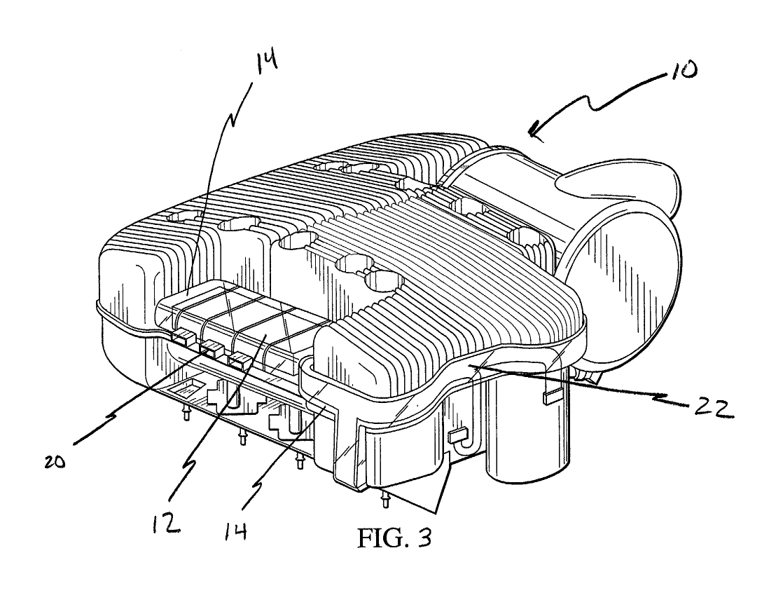

Referring in combination to FIGS. 1-3, a preferred embodiment of the present invention is illustrated. FIG. 1 shows a schematic view of an IAFM utilizing the present invention. Preferably, a PCM 12 is mounted on the plenum cover 14 of the upper air intake manifold 16 or the IAFM 10. The PCM 12 is preferably formed to match the contours of the plenum cover 14. This allows the plenum cover 14 to form a first layer on a first side of the PCM 12. The PCM 12 may include a circuit board, active or passive circuits such as a microprocessor, or an application-specific integrated circuit.

The plenum cover 14 preferably seals the air intake manifold 16 from contaminants and ambient pressure. Preferably, the plenum cover 14 is formed from plastic or metal, although other materials such as nylon, stamped metal or other casting may be utilized. If high thermal conductivity and increased EMI shielding is desired, metal is the preferred material. Depressions 20 are preferably formed in the plenum cover 14 to allow clearance for surface-mounted components of the PCM 12. Airflow through the runners, passages, and plenum cover 14 of the intake manifold 16 or IAFM 10 allow the plenum cover 14 to act as a heat sink for the PCM 12 by using the airflow into the upper intake manifold 16 as a heat-dissipating mechanism.

The PCM 12 is preferably bonded to the plenum cover 14, but it may be attached with any type of fastener as known in the art. Alternatively, a thermally conductive tape may be used to attach the PCM 12 to the plenum cover 14 if better thermal conductivity is desired.

The present invention also preferably includes a wiring harness 22 extending from the PCM 12. The wiring harness 22 is preferably attached to the plenum cover 14 and the intake manifold 16 in the same manner as the PCM 12. It can also be attached by fasteners as known in the art. The wiring harness 22 preferably connects the PCM 12 to at least one ignition coil 24 and at least one fuel injector 26. The wiring harness 22 may also provide connection to any other component controlled by the PCM 12, or it could connect to components that supply feedback to the PCM 12.

The preferred embodiment of the present invention preferably includes a second layer 28 of formed material on the second side of the PCM 12. This is the side opposite the plenum cover 14. This second layer 28 is also present on the wiring harness 22. This second layer 28 of formed material is preferably preformed to match the contours of the PCM 12 and the wiring harness 22 and then attached to the PCM 12 and the wiring harness 22. The second layer 28 in combination with the plenum cover 14 forms a constrained layer damping treatment around the PCM 12 and the wiring harness 22. To further increase the damping effects of the present invention, the PCM 12 and wiring harness 22 are coated with an encapsulant that acts to shear and absorb vibration. A preferred encapsulant is silicon gel, although any material known to have vibration and/or damping characteristics may be utilized. The thickness and density of the silicon gel may be preferably varied according to the amount of damping desired.

In an alternative embodiment of the present invention, the constrained layer treatment is applied to only a wiring harness 22. This allows an encapsulated wiring harness 22 to be utilized to provide any type of connection, not just a connection between a PCM 12 and other components. In this preferred embodiment, a first layer of material is applied to a first side of a wiring harness 22, and a second layer of material is applied to the opposite side of the wiring harness 22. These layers of material form a constrained layer treatment around the encapsulated wiring harness 22. The layers can be formed from metal, plastic, or any other material, depending on the characteristics desired. In this embodiment, the first layer of material functions like the plenum cover 14 of the first described embodiment. Preferably, the entire wiring harness 22 is covered, but sections of the wiring harness 22 may be left uncovered if necessary.

The present invention also provides a method for reducing the effects of both noise emitted from a powertrain, and EMI emitted from a powertrain on a control module. This allows a designer to position the control module in a more space-efficient manner, such as directly on the upper intake manifold 16 of the vehicle, as illustrated and described. The method of the present invention can also be utilized to shield other components from similar types of interference from other vehicular components, or to shield only the wiring harness 22. The method includes the step of providing a control module with a wiring harness 22 extending therefrom. The control module is preferably a PCM 12. The PCM 12 and wiring harness 22 are preferably coated with a damping material, such as silicon gel. The PCM 12 is preferably mounted on the plenum cover 14 of the upper intake manifold 16 of a vehicle. The plenum cover 14 is preferably metal or plastic. Should increased EMI shielding be desired, metal is the preferable material. A constraining layer 28 of material is mounted on the side of the PCM 12 and wiring harness 22 opposite the plenum cover 14. This configuration forms a sealed constrained layer treatment around both the PCM 12 and wire harness 22 that protects the components from NVH and EMI. The preferable mounting configuration on the upper intake manifold 16 of the vehicle also allows the airflow of the intake manifold 16 to act as a heat-dissipating mechanism to cool the PCM 12.

The preferred embodiments of the present invention allow the PCM 12 to be mounted in a position that allows additional sensor/actuator integration, such as integration of an electronic throttle body, EGR, fuel pressure sensors, sensors for mass air flow, engine temperature, engine speed and crankshaft position. The preferred embodiments of the present invention also provide greater protection from NVH and EMI than prior art configurations. An additional advantage of the preferred embodiments of the present invention is that, due to the integration of the PCM 12, wiring harness 22, and features such as electronics cooling, NVH and EMI shielding with the intake manifold 16, package size, part count, weight, and cost are reduced. The cost and complexity of the wiring harness 22 is also further reduced due to the “on-engine” location of the PCM 12 in the preferred embodiments of the present invention.

It should be noted that there could be a wide range of changes made to the present invention without departing from its scope. As noted, damping materials other than silicon gel may be used to coat the PCM 12 and the wiring harness 22. Alternatively, the damping material can be eliminated from the embodiments. The wiring harness 22 can attach to any component in the engine system, and may be routed differently than described. Should a stamped plenum cover 14 be used, depressions in the stamped cover can provide clearance for surface mount components of the PCM 12. The PCM 12 could also have a populated flex substrate, or a ceramic or FR-4 substrate with interconnects to the wiring harness 22. Some or all of these components could be coated with an appropriate encapsulant. This method could also be applied to other components in need of NVH or EMI damping. Thus, it is intended that the foregoing detailed description be regarded as illustrative rather than limiting and that it be understood that it is the following claims, including all equivalents, which are intended to define the scope of the invention.

What is claimed is:

1. A constrained layer damping system for use in an integrated air fuel module having a control module mounted thereon, said constrained layer damping system comprising:
a control module coated with an encapsulant;
a wiring harness coated with an encapsulant and extending from said control module;
a first layer of formed material on a first side of said wiring harness and a first side of said control module; and
a second layer of formed material on a second side of said wiring harness and a second side of said control module.

2. The constrained layer damping system of claim 1, wherein said first layer is an intake manifold plenum cover.

3. The constrained layer damping system of claim 2, wherein said encapsulant is silicon gel.

4. The constrained layer damping system of claim 3, wherein said first and said second layers are bonded to said wiring harness and said control module.

5. The constrained layer damping system of claim 3, wherein said second layer is bonded to said control module and said control module is attached to said intake manifold cover with a thermally conductive tape.

6. The constrained layer damping system of claim 4, wherein said wiring harness is attached to said intake manifold plenum cover by fasteners.

7. The constrained layer damping system of claim 4, wherein said intake manifold plenum cover is plastic.

8. The constrained layer damping system of claim 4, wherein said intake manifold plenum cover is metal.

9. The constrained layer damping system of claim 8, wherein said second layer is metal.

10. The constrained layer damping system of claim 8, wherein said second layer is plastic.

11. The constrained layer damping system of claim 10, wherein said wiring harness extends from said control module and connects to at least one ignition coil and at least one fuel injector.

12. A constrained layer damping system, said constrained layer damping system comprising:
a wiring harness coated with an encapsulant;
a first layer of formed material on a first side of said wiring harness; and
a second layer of formed material attached to a second side of said wiring harness such that said wiring harness is between said first and said second layers.

13. A method for reducing the effects of noise emitted from a powertrain and electromagnetic interference on a control module, said method comprising the steps of:
providing a control module with a wiring harness extending therefrom;
encapsulating said control module and said wiring harness with a damping material;
mounting said control module on an air intake manifold plenum cover; and
mounting a constraining layer of material on the side of said control module and said wiring harness opposite said air intake manifold plenum cover.

14. The method of claim 13, further comprising the step of cooling said control module by using said air intake manifold plenum cover as a heat sink.

15. The method of claim 14, wherein the airflow into said air intake manifold plenum cover dissipates heat from said control module.

16. The method of claim 15, wherein said encapsulant is a silicon gel.

17. The method of claim 16, wherein said air intake manifold plenum cover is metal and serves to reduce the effect of electromagnetic interference on said control module.

18. The method of claim 17, wherein said constraining layer is plastic.

19. The method of claim 17, wherein said constraining layer is metal.
